(19) United States
(12) Patent Application Publication
(10) Pub. No.: US 2017/0246488 A1
(43) Pub. Date: Aug. 31, 2017

(54) MOUNTING BRACKET FOR A PORTABLE EXTINGUISHER

(71) Applicant: ROME, BISCHEIM (FR)

(72) Inventor: Patrick MOSCHEROSCH, REICHSTETT (FR)

(21) Appl. No.: 15/440,691

(22) Filed: Feb. 23, 2017

(30) Foreign Application Priority Data
Feb. 25, 2016 (FR) 1651564

(51) Int. Cl. A62C 13/78; F16M 13/02; F16B 1/00; H01F 7/02; H01F 1/032

(52) U.S. Cl. CPC A62C 13/78; H01F 7/0252; H01F 1/032; F16B 1/00; F16M 13/022; F16B 2001/0035

(57) ABSTRACT

The invention relates to a mounting bracket (1) for a portable extinguisher (2) comprising a hook (3), said mounting bracket (1) comprising:

a base (10) having a front face (11) configured for contact with the hook (3) of the extinguisher (2) and a rear face (12) configured to rest against a wall (4), and

at least one permanent magnet (20) comprising neodymium, and

a groove (30), formed in the front face (11) of the base (10) and configured to cooperate with the hook (3) of the extinguisher (2).

### FIELD OF THE INVENTION

The invention relates to the field of fire safety and more particularly to supports allowing attachment of these portable extinguishers.

### TECHNOLOGICAL BACKGROUND

A portable extinguisher is a firefighting device capable of projecting or spreading an appropriate substance—called an “extinguishing agent”—so as to extinguish an incipient fire, which is designed to be carried and operated manually. Such an extinguisher has a mass less than or equal to twenty kilograms.

On the French market, there are currently more than fifty models of portable extinguishers with different sizes and contents. Portable extinguishers can in fact have a weight comprised between approximately 6 kilograms and twenty kilograms and contain water with an additive, polyvalent powders or carbon dioxide (CO₂).

Each of these portable extinguishers must comprise an attachment hook associated with it. The portable extinguisher is then certified in combination with its attachment hook, which can consequently not be modified during its installation.

Extinguishers can in particular be placed on the ground on claddings or attached using their bracket to a metal column of the IPN type (meaning an I-beam with a Normal Profile). The same site can in any case comprise several different types of portable extinguishers (having different dimensions, weights, contents and/or marks/sources), each comprising a distinct attachment hook.

In order to allow the attachment of these portable extinguishers to metal columns without drilling, magnetic mounting brackets comprising a U-shaped hook attached to magnetized plates have been proposed. These supports, however, are not universal to the extent that they are not suitable for allowing the attachment of any portable extinguisher, independently of the shape of its hook. Moreover, these supports are not capable of reliably attaching the heaviest extinguishers, in particular when the metal column has several successive layers of paint which reduce the adhesion force of the supports. It is therefore often necessary to also attach retainer flanges so as to reinforce the attachment of the plates to the column and to limit the risks of detachment. In addition, during operation the U-shaped hooks of these plates have a tendency to deform and therefore to attach the extinguisher less well. Finally, the plates employed have large dimensions (generally 300 mm×400 mm or 160 mm×500 mm) which, in addition to not being esthetically pleasing, are often difficult to attach to the selected metal wall due to their great size.

It has also been proposed to attach the hook by drilling directly into the metal column. Such drilling is not, however recommended and may be prohibited, depending on the country, so as not to modify the structure of the (IPN) column and its mechanical strength. What is more, such drilling involves a non-negligible loss of time and therefore increases the installation cost of the extinguisher.

Finally, it is customarily strongly not recommended to attach the hooks to insulating claddings. These claddings generally have in fact a thickness comprised between 0.50 and 0.88 mm, so that screwing the hooks into these claddings using self-threading screws does not allow the extinguisher to be retained over time.

### SUMMARY OF THE INVENTION

One object of the invention is therefore to propose a mounting bracket for a portable extinguisher which is capable of attaching a portable extinguisher against a metal column of the IPN type independently of the number of paint layers which may cover said metal column, and which in addition uses little space and is capable of cooperating with any existing type of hook, no matter what the classification (water, powder or CO₂), the size, the weight or the origin of the associated extinguisher.

For this purpose, the invention proposes a mounting bracket for a portable extinguisher comprising a hook, said mounting bracket comprising:

a base having a front face configured to contact with the hook of the extinguisher and a rear face configured to rest against a wall, and

at least one permanent magnet comprising neodymium, and

a groove, formed in the front face of the base and configured to cooperate with the hook of the extinguisher.

Certain preferred but not limiting features of the mounting bracket described above are the following, taken individually or in combination;

the mounting bracket comprises at least two permanent magnets comprising neodymium, between two and six for example,

the base has the shape of a disk,

the base has a maximum width less than or equal to 200 mm, preferably less than or equal to 160 mm, approximately 155 mm for example,

the groove has a T-shaped section,

the groove is discontinuous and comprises two disjoint sub-portions,

the base is made of plastic, typically of acrylonitrile butadiene styrene,

the base further comprises stiffening ribs, extending from its rear face,

the mounting bracket further comprises at least one permanent magnet comprising ferrites,

the mounting bracket comprises between four and six permanent magnets comprising neodymium and no permanent magnet comprising ferrites, or four permanent magnets comprising neodymium and two permanent magnets comprising ferrites.

### BRIEF DESCRIPTION OF THE DRAWINGS

Other features, aims and advantages of the present invention will stand out better upon reading the detailed description that follows, and referring to the appended drawings given by way of non-limiting examples and wherein:

FIG. 1 is a perspective view of the front face of an exemplary embodiment of a mounting bracket for a portable extinguisher conforming to the invention,

FIG. 2 is a perspective view of the rear face of the mounting bracket of FIG. 1,

FIG. 3 is a side view of the mounting bracket of FIG. 1 at the groove,

FIG. 4 is a side view of an exemplary embodiment of a mounting bracket of a portable extinguisher according to the invention, attached to a metal panel and to which is attached an example of a portable extinguisher.

### DETAILED DESCRIPTION OF AN EMBODIMENT

In a manner known per se, a portable extinguisher 2 comprises a closed tank having an upper wall which has an opening, the contour whereof has a generally circular shape, a dipping tube assembly with a generally cylindrical shape and an extinguisher head 2. An attachment system of the ring or attachment notch type 3a is further fixedly attached to the portable extinguisher 2, at the upper wall of the closed tank. This attachment system is configured to cooperate with a hook 3, which is certified with the associated extinguisher 2.

As indicated previously, there exist several types of portable extinguishers 2, each of which can have a different shape, size and weight depending on the origin (the mark) of the extinguisher 2 and its content. Moreover, the hooks 3 differ from one extinguisher 2 to another, their only common point being the presence of two through openings formed in the hook 3.

These through opening generally have a diameter of the order of 6.5 mm allowing passage of a screw of the M6 type. The center-to-center distance between the through openings varies, however, from one hook 3 to another.

In order to allow the attachment of any type of extinguisher 2 on a metal panel 4 independently of the shape of the hook 3 with which it is certified, the invention proposes a mounting bracket 1 comprising:

a base 10 having a front face 11 configured to contact with the hook 3 of the extinguisher 2 and a rear face 12 configured to face the metal panel 4,

at least one permanent magnet 20 comprising neodymium, and

a groove 30 formed in the front face 11 of the base 10 and configured to cooperate with the hook 3 of the extinguisher 2.

Here, what is meant by a metal panel 4 is any type of wall comprising at least one metal area, typically a metal column (particularly IPN), a wall (which can be a concrete wall) comprising an integral or applied metal plate, etc.

Such a configuration thus makes it possible, thanks to the implementation of permanent magnets 20 comprising neodymium, to provide effective and reliable attachment of any type of portable extinguisher 2 onto a panel 4 without resorting to drilling, independently of the number of layers of paint covering this panel 4, while still having a compact size.

The mounting bracket 1 may comprise only magnets comprising neodymium, or as a variant also comprise one or more magnets comprising ferrites.

One example of permanent magnets 20 comprising neodymium which can be used has a lifting force of approximately 26 kg and a shearing force of approximately 7 kilograms per magnet 20, while an example of permanent magnets comprising ferrites which can be used has a lifting force of approximately 8 kilograms and a shearing force of approximately 2.7 kilograms.

Permanent magnets 20 comprising neodymium can also comprise iron and boron.

The number and the type of permanent magnets 20 attached to the mounting bracket 1 are selected so as to support, once assembled into the mounting bracket 1, a lifting force at least equal to 80 kilograms and preferably at least 100 kilograms, and a shearing force at least equal to 25 kilograms, so as to guarantee the attachment and clamping of any type of extinguisher 2, regardless of the coating of the metal panel 4.

Thus, in a first exemplary embodiment, the mounting bracket 1 can comprise four permanent magnets 20 comprising neodymium and two permanent magnets comprising ferrites. This first example thus makes it possible to obtain a total lifting force for the mounting bracket 1 of approximately 120 kilograms and a total shearing force of approximately 33 kilograms, when the permanent magnets 20 described above are used (i.e. magnets having a lifting force and a shearing force of 26 kg and 7 kg respectively for permanent magnets 20 based on neodymium and 8 kg and 2.7 kg respectively for permanent magnets 20 based on ferrites).

In a second exemplary embodiment, the mounting bracket 1 can comprise only four permanent magnets 20 comprising neodymium. This second example thus makes it possible to obtain a total lifting force of approximately 104 kilograms and a total shearing force of approximately 28 kilograms, with the permanent magnets 20 described above.

In a third exemplary embodiment, the mounting bracket 1 can comprise only six permanent magnets 20 comprising neodymium. This third example then makes it possible to obtain a total lifting force of approximately 156 kilograms and a total shearing force of approximately 42 kilograms, with the permanent magnets 20 described above.

Moreover, the groove 30 allows, in combination with a mounting bracket, the attachment of any type of extinguisher hook 3, whether horizontally or vertically, the orientation of the attachment being capable of being modified by simply orienting the groove 30 in the desired direction during attachment of the bracket 1 against a metal bracket 1.

It is sufficient in fact to introduce an attachment member such as a screw 5 into one of the through openings of the hook 3, then to insert the head of the screw 5 into the groove 30 and to allow it to slide, with the hook 3, along the groove 30 so as to connect and block the extinguisher 2 on the mounting bracket 1. It will be recalled in fact that all hooks 3 known at present comprise two through openings.

In one embodiment, a screw 5, of the M6 type for example when the opening of the hook 3 has a diameter approximately equal to 6.5 mm, is introduced into each through opening and blocked on the hook 3 by means of a corresponding nut. It is then sufficient to introduce each screw head into the groove 30 to attach the extinguisher 2 to the mounting bracket 1.

It will be noted that the groove 30 thus allows, whatever the center-to-center distance between the through openings formed in the hook 3, to attach said hook 3 by means of two attachment members to the mounting bracket 1. The attachment of the extinguisher 2 to the mounting bracket 1 is therefore simple, fast and cheap, because it requires only the use of one or two screws 5 and as many nuts 6 (or any other equivalent parts). The mounting bracket is also universal because it allows the attachment of any kind of hook 3.

In one embodiment, the base 10 of the mounting bracket 1 has a periphery whereof the maximum width L is less than 200 mm, preferably less than or equal to 160 mm, for example on the order of 155 mm. Here “width L” will be understood to mean the distance between two parallel straight lines (or “support lines”) which are tangent to the closed curve formed by the periphery of the base 10 at two distinct points. The maximum width L then corresponds to the largest width L of the periphery.

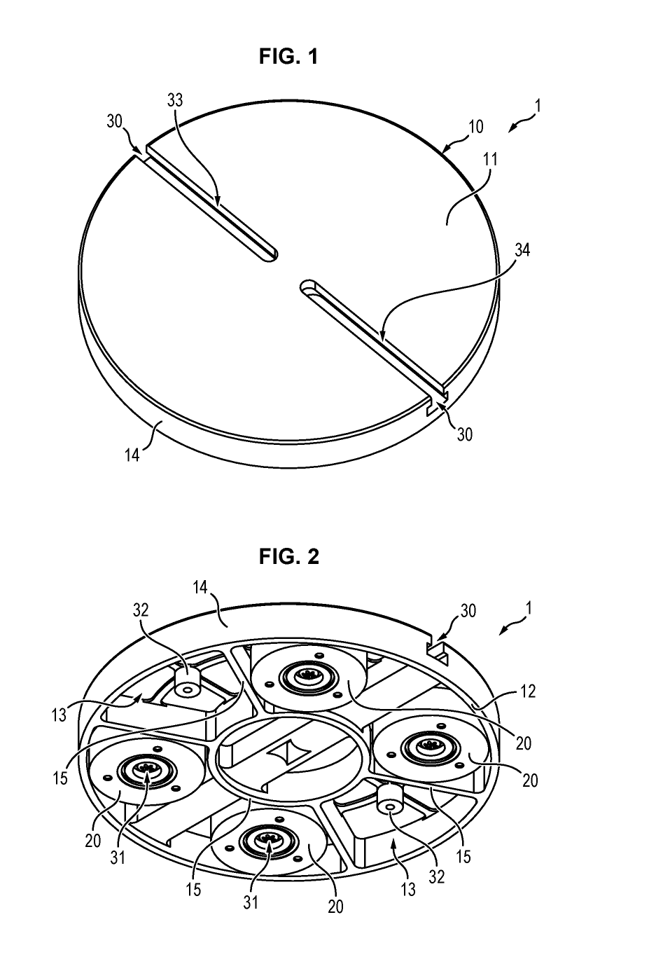

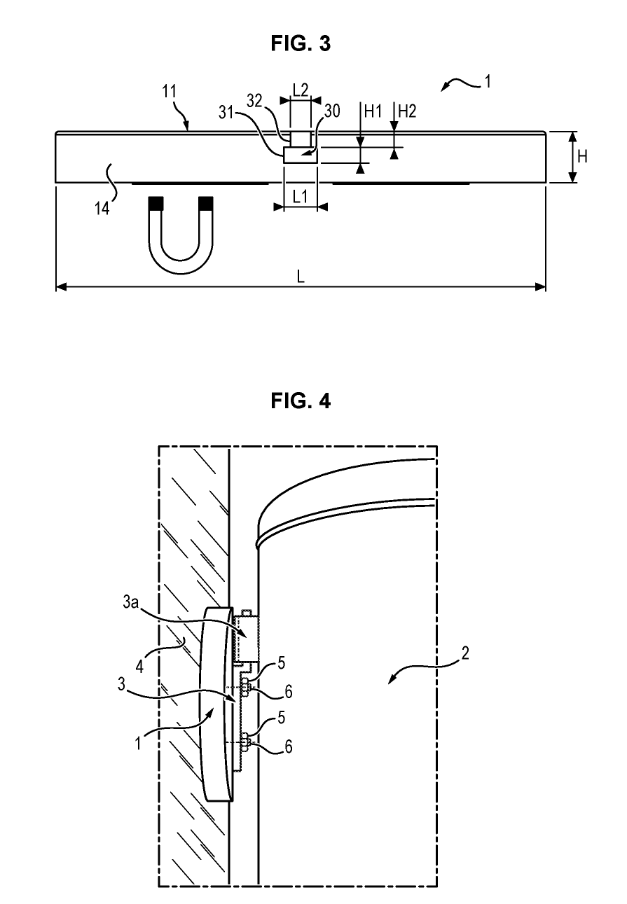

In one embodiment, the periphery of the base 10 is circular overall, the maximum width L then being equal to the external diameter of the circle (see FIG. 1). As a variant, the periphery of the base 10 could for example be square or rectangular, the maximum width L then corresponding to their diagonal.

Such a compactness of the base 10 is allowed in particular by the implementation of permanent magnets 20 comprising neodymium, which make it possible to obtain a very high lifting force on a small contact surface.

Advantageously, a base 10 having a maximum width L less than or equal to 160 mm is then generally masked by the tank of the portable extinguisher 2, when it is attached to the bracket 1 via its hook 3. Thus, the mounting bracket 1 can not only be placed on any metal panel 4 as long as the size of the portable extinguisher 2 allows it, but in addition the overall esthetics of the mounting bracket 1 and of the portable extinguisher 2 is improved.

The base 10 can be solid, in which case the permanent magnets 20 can be attached to the rear face 12 of the base 10 or embedded in the mass.

As a variant, so as to reduce the quantity of material required for making the base 10, its bulk and its overall weight, the base 10 can have local recesses 13 configured to received one or more of the permanent magnets 20.

These recesses 13 can be blind and be formed in the rear face 12 of the base 10, so as to leave the smooth front face 11 (other than the groove 30) and thus improve its esthetic finish.

For example, the base 10 can have a peripheral edge 14, extending substantially perpendicularly from the front face 11 toward the rear face 12. The front face 11 and the peripheral edge 14 then have an overall shape of a cup.

Ribs 15 for reinforcing the base 10 can then be formed between the faces 11, 12 of the base 10 and the peripheral edge 14. In the case of a base 10 with the shape of a disk, the ribs 15 can for example extend radially from the center of the base 10 toward the peripheral edge 14. The ribs 15 can be rectilinear or curved. As a variant or a complement, the base 10 can further comprise a circular central rib 15, coaxial with the peripheral edge 14 and from which ribs 15 extend radially.

The ribs 15 thus define the recesses 13, with the peripheral edge 14 and possibly the central rib 15.

The height H (the distance between the front face 11 and the rear face 12) of the base 10 depends on the thickness of the permanent magnets 20 selected and can be comprised between approximately ten millimeters and thirty millimeters. For example, the base 10 can have a height (within 5%) of 16.5 mm. Such a height is typically practicable for a circular base 10 having a diameter less than or equal to 200 mm.

The groove 30 leads into the front face 11 of the base 10. The front face 11 and the rear face 12 are preferably substantially planar so as to facilitate the attachment of the bracket 1 on a flat surface (such as a wall or a column) and retaining a portable extinguisher 2.

In one embodiment, the groove 30 has a T-shaped cross section. In other words, the bottom 31 of the groove 30 is larger than its mouth 32. The cross section of the bottom 31 of the groove 30 and the cross section of the mouth 32 of the groove 30 can be rectangular and/or rounded. The groove 30 can be symmetrical.

The groove 30 can for example have (within 5%):

at the bottom 31, a width L1 (dimension perpendicular to the direction of extension of the groove 30) of approximately 10.5 mm for a depth H1 (dimension between the front face 11 and the rear face 12) of approximately 5 mm,

at the mouth 32, a width L2 of approximately 6.5 mm for a depth H2 of approximately 5 mm.

These dimensions of the groove 30 can in particular be implemented for a base 10 having a thickness of 16.5 mm.

A length (dimension in the direction of extension of the groove 30) of the groove 30 is then comprised between one-third of the maximum width L of the base 10 and the maximum width L of the base 10.

One end of the groove 30 is preferably closed so as to block in translation the head of the screws 5 allowing suspension of the hook 3 of an extinguisher 2.

The groove 30 can be continuous (i.e. in a single portion) or discontinuous (i.e. in several portions).

So as to facilitate the introduction of the hook 3 of the portable extinguisher 2 into the groove 30, the groove 30 preferably leads to the peripheral edge 14 of the base 10. As a variant, the groove 30 can also be blind and not lead to the peripheral edge 14 of the base 10, in which case an opening, larger than the groove 30, can be provided at one of its free ends so as to allow the introduction of the hook 3 of the extinguisher 2 into the groove 30.

In one exemplary embodiment, the groove 30 is discontinuous and comprises two sub-portions 33, 34 extending in alignment with one another and covering approximately ⅘ of the maximum width L of the base 10. These sub-portions 33, 34 of the groove 30 are of equal length and both lead to the peripheral edge 14 of the base 10. In the case of a circular base 10, the groove 30 can be aligned with a diameter of the base 10, in which case the base 10 is then symmetrical.

The base 10 can be obtained either by injection molding of plastic, or by machining from a solid (using a ripper for example). The plastic can in particular comprise any injectable polymer which is shock-resistant and does not distort under load, typically acrylonitrile butadiene styrene (ABS).

When the base 10 is hollow and obtained by injection of ABS type plastic, the thickness (quantity of matter) of the front face 11 and of the peripheral edge can be on the order of 1 to 3 mm (within 5%) for a base the diameter whereof is less than or equal to 200 mm.

As a variant, the base 10 can be made of metal (aluminum, steel, etc.), in which case the base 10 can be obtained by casting or by stamping.

Each permanent magnet 20 can be attached by any means to the base 10 by its rear face 12. For example, each magnet 20 can be fixedly attached to a threaded rod 31 (respectively a threaded nipple), while the base 10 can comprise, at its rear face 12, threaded nipples 32 (respectively threaded rods), with complementary shapes and dimensions. It is then sufficient to screw the threaded rod 31 of the permanent magnets 20 on an associated nipple (or the reverse) so as to secure them with the base 10. As a variant, the magnets 20 could be attached in the recesses 13 by snap-fitting, interlocking, etc.

In the exemplary embodiment illustrated on the appended figures, the base 10 is circular and comprises, on the side of the rear face 12, a central circular rib 15 coaxial with the peripheral edge 14 of the base 10, from which four rectilinear ribs 15 extend radially. The walls delimiting the groove 30 form a crowning which projects on the side of the rear face 12 and thus participate in the stiffening of the bracket 1. It will be noted here that the ribs 15 extend on either side of the groove 30 walls, thus defining, with said walls, six recesses 13 each capable of receiving a permanent magnet 20. A threaded nipple 32 projects from the bottom 31 of each recess 13 configured to attach a threaded rod 31 associated with a permanent magnet 20.

Permanent magnets 20 comprising neodymium comprising ferrites can have similar shape and dimensions.

For example, permanent magnet 20 can have (within 5%) a width on the order of forty millimeters, for example 43 mm, for a thickness (minus the threaded rod 31 or the threaded nipple 32) on the order of 12 mm. Such permanent magnets 20 can then have lifting and shearing forces, described above in relation with the first, second and third exemplary embodiments, for reduced use of space.

These permanent magnets 20 can have any shape capable of being integrated into the base 10. For example, the permanent magnets 20 can have the shape of a disk, of a square, of a triangle, etc.

Permanent magnets 20 can optionally be covered with a rubber coating so as to avoid scratching, discoloration, etc. of the surface to which the mounting bracket 1 is attached.

The mounting bracket 1 can be sold pre-assembled, i.e. with permanent magnets 20 previously applied and attached to the base 10, or as a variant as a kit, meaning that the base 10 can be sold separately and then assembled with permanent magnets 20, of which at least one comprises neodymium.

The number of permanent magnets 20 comprising neodymium can be adjusted depending on the acquisition cost selected for the mounting bracket 1 and the type of portable extinguishers 2 capable of being hooked to the bracket 1. For a mounting bracket 1 capable of carrying any type of portable extinguisher 2, at least four permanent magnets 20 comprising neodymium are preferably attached to the base 10.

The mounting bracket 1 is then ready to be attached to a metal panel 4.

In order to attach the bracket 1, it is sufficient to apply the rear face 12 of the base 10 against the metal panel 4.

Any type of extinguisher 2 can then be hooked to the mounting bracket 1 through its hook 3 and, as indicated above, with one or two screws 5 and with a nut 6 (or any other equivalent attachment member).

1. A mounting bracket for a portable extinguisher comprising a hook, said mounting bracket comprising:
a base having a front face configured to contact with the hook of the extinguisher and a rear face configured to rest against a wall, and
at least one permanent magnet comprising neodymium, and
a groove, formed in the front face of the base and configured to cooperate with the hook of the extinguisher.

2. The mounting bracket according to claim 1, comprising at least two permanent magnets comprising neodymium.

3. The mounting bracket according to claim 1, wherein the base has the shape of a disk.

4. The mounting bracket according to claim 1, wherein the base has a maximum width less than or equal to 200 mm.

5. The mounting bracket according to claim 1, wherein the groove has a T-shaped section.

6. The mounting bracket according to claim 1, wherein the groove is discontinuous and comprises two disjoint sub-portions.

7. The mounting bracket according to claim 1, wherein the base is made of plastic.

8. The mounting bracket according to claim 1, wherein the base further comprises stiffening ribs extending from its rear face.

9. The mounting bracket according to claim 1, further comprising at least one permanent magnet comprising ferrites.

10. The mounting bracket according to claim 1, said bracket comprising:
between four and six permanent magnets comprising neodymium and no permanent magnet comprising ferrites, or
four permanent magnets comprising neodymium and two permanent magnets comprising ferrites.

11. The mounting bracket according to claim 1, comprising between two and six permanent magnets comprising neodymium.

12. The mounting bracket according to claim 1, wherein the base has a maximum width less than or equal to 160 mm.

13. The mounting bracket according to claim 1, wherein the base has a maximum width of 155 mm.

14. The mounting bracket according to claim 1, wherein the base is made of acrylonitrile butadiene styrene (ABS).
